(19) United States
(12) Patent Application Publication
(10) Pub. No.: US 2026/0154787 A1
(43) Pub. Date: Jun. 4, 2026

(54) BACKGROUND REPLACEMENT IN VIDEO CONFERENCE WITH OCCLUDED BACKGROUND PRIOR

(71) Applicant: Intel Corporation, Santa Clara, CA (US)

(72) Inventors: Mor Hadar, Kiryt Ono (IL); Rony Zatzarinni, Tel Aviv (IL); Dor Barber, Herzliya (IL); Hava Matichin, Petah Tikva (IL)

(73) Assignee: Intel Corporation, Santa Clara, CA (US)

(21) Appl. No.: 19/451,750

(22) Filed: Jan. 16, 2026

(51) Int. Cl. G06T 5/50; G06T 7/194

(52) U.S. Cl. CPC G06T 5/50; G06T 7/194; G06T 2207/20221

(57) ABSTRACT

Systems and methods for background replacement in video using an occluded background prior that is dynamically maintained across frames. An input video frame is received at a separator, which reads previous background data from memory and generates a foreground matting (a per-pixel probability map indicating the foreground subject) based on the input frame and the previous background data. The system determines weights from the foreground matting and an accumulation map (a temporal exposure/confidence history), and updates the previous background data based on a weighted blending of the input frame and the previous background data. Updates for pixels classified as foreground are withheld to prevent leakage of the foreground subject into the background model. The updated background data is stored in memory for subsequent frames. Based on the foreground matting, a background replacer generates an output frame in which the foreground is preserved, and the background is replaced or modified.

### TECHNICAL FIELD

This disclosure relates generally to image processing, and in particular to background replacement in video conferencing with occluded background prior.

### BACKGROUND

Background replacement in video conferencing applications is typically achieved using segmentation or matting models that distinguish between the foreground subject and the background. However, these models often encounter significant challenges, particularly in saturated regions that are common in high dynamic range scenes. Additionally, background replacement models produce coarse boundaries, especially at higher resolutions, failing to accurately segment areas with fine details, such as hair. In video conferencing applications, it is important that the model predictions are temporally coherent. Foreground segmentation is an ambiguous task because the model needs to understand which semantic objects are associated with the foreground person (such as a hat, a person holding a pen, or wearing a wristwatch). There is a need for a more robust and efficient method that improves segmentation accuracy, ensures temporal coherence, and handles fine details in high-resolution video conferencing environments.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawing.

FIG. 1 is a block diagram of a temporal noise reduction (TNR) system that can be used in a background replacement system, in accordance with various embodiments.

FIG. 2 is a block diagram of a foreground segmentation system that can be used in a background replacement system.

FIG. 3 is a block diagram of a background replacement system, in accordance with various embodiments.

FIG. 4 is a diagram showing a frame illustrating the four different regions of overlap of consecutive frames of a video, in accordance with various embodiments.

FIGS. 5A-5F illustrate pairs of current images with corresponding region maps, in accordance with various embodiments.

FIG. 6 is a flowchart showing a method for background replacement, in accordance with various embodiments.

FIG. 7 is a block diagram of an example DNN system, in accordance with various embodiments.

FIG. 8 illustrates an example DNN, in accordance with various embodiments.

FIG. 9 is a block diagram of an example computing device, in accordance with various embodiments.

### DETAILED DESCRIPTION

### Overview

Systems and methods are provided herein for background replacement in video conferencing applications. Background replacement in video conferencing applications refers to the process of digitally substituting or modifying the visual background behind a participant during a live video call. This technique typically involves identifying and separating the foreground subject from the surrounding environment using computer vision models. Background replacement is useful because it enhances privacy, reduces distractions, and allows users to present themselves in a more professional or personalized setting, regardless of their actual physical location.

Background replacement in video conferencing often relies on matting or segmentation models to separate the foreground from the background, and there are several different approaches to background replacement. Traditional trimap-based matting techniques rely on manually annotated trimaps to distinguish between known foreground, background, and unknown regions. Methods such as KNN Matting, Bayesian Matting, and Poisson Matting use these trimaps to estimate the alpha matte and foreground colors. While these approaches can yield high-quality results, they are not practical for real-time video conferencing due to their computational intensity and the need for manual input. Even deep learning-based trimap matting, such as FBA Matting, still depends on accurate trimaps, which are difficult to obtain in dynamic, real-world scenarios.

Another approach involves background-based matting methods, which utilize an additional background image captured without the subject present to improve matting accuracy. This approach provides a strong cue for separating the foreground from the background, but it requires the user to capture a clean background image in advance. This requirement introduces inconvenience and is sensitive to changes in camera settings, lighting, or background motion, which can lead to inconsistencies and reduced performance in practical application.

Another approach to background replacement uses semantic segmentation models, such as DeepLabV3 and Mask RCNN. The semantic segmentation models assign a class label to each pixel without auxiliary inputs, enabling the identification of human subjects. However, directly using binary segmentation masks for background replacement often results in visible artifacts, especially around fine details like hair, and produces coarse boundaries. More recent auxiliary-free matting methods, such as MODNet and HAttMatting, attempt to estimate the alpha matte directly from the image without external input. While promising, these methods often struggle with generalization to diverse environments, lack temporal coherence, and have difficulty handling fine details in high-resolution video conferencing.

Other approaches to background replacement include recurrent architectures to exploit temporal information. These architectures have been introduced to address the challenge of temporal coherence in video matting. Some examples utilize a recurrent neural network architecture that processes multiple frames and incorporates its own previous predictions to guide the matting process. By explicitly modeling temporal dependencies, these methods improve the consistency of the alpha matte across consecutive frames and enhance the overall matting quality. However, despite these advancements, recurrent architectures often require further optimization to achieve real-time performance at high resolutions, which is essential for practical deployment in video conferencing and similar applications.

Another approach is high-resolution matting with dual-network architecture, which aims to achieve both real-time performance and high-quality results in background replacement tasks. This technique uses a dual-network design, where a base network generates low-resolution predictions and a refinement network selectively processes high-resolution patches to preserve fine details. The architecture enables real-time operation at resolutions such as 4K and 30 frames per second, while maintaining the fidelity of intricate features like hair. Nevertheless, these methods still depend on a pre-captured background image and may encounter difficulties when dealing with dynamic backgrounds, which can limit their applicability in real-world video conferencing environments.

In general, the various background replacement approaches struggle with saturated regions in high dynamic range scenes and tend to produce rough edges, especially at higher resolutions, making it difficult to capture fine details. Achieving consistent results over time is also challenging, as the model must identify which objects belong to the foreground subject. Thus, there remains a need for a more reliable and efficient solution that delivers accurate segmentation, temporal consistency, and improved handling of fine details in high-resolution video conferencing.

In various implementations, systems and methods are provided for background replacement, including leveraging the temporal noise reduction (TNR) block, which is commonly available in image signal processors (ISPs). The background replacement systems and methods include constructing and maintaining a dynamic background model without user intervention. The dynamic background model (i.e., the background prior) can be provided as a reference to a deep neural network for foreground segmentation. The techniques result in significantly enhanced segmentation accuracy and visual quality while minimizing computational and power overheads, resulting in high-quality, real-time background replacement suitable for use in real time video applications, such as video conferencing applications.

For purposes of explanation, specific numbers, materials, and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phrase “A or B” means (A), (B), or (A and B). For the purposes of the present disclosure, the phrase “A, B, and/or C” or the phrase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operant of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressing listed or inherent to such method, process, device or systems. Also, the term “or” refers to an inclusive “or” and not to an exclusive “or”.

The systems, methods, and devices of this disclosure each have several innovative aspects, no single one of which is solely responsible for all desirable attributes disclosed herein. Details of one or more implementations of the subject matter described in this specification are set forth in the description below and the accompanying drawings.

### Example Background Replacement System

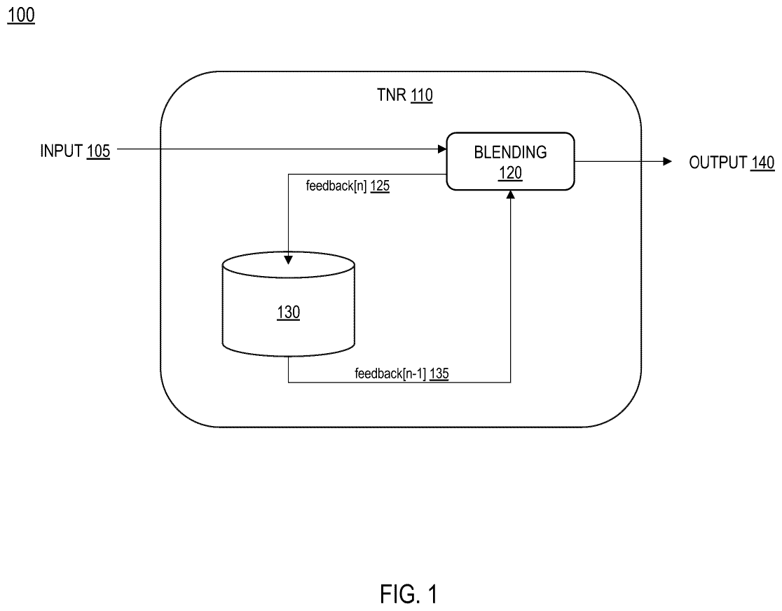

FIG. 1 is a block diagram 100 of a temporal noise reduction (TNR) system 110 that can be used in a background replacement system, in accordance with various embodiments. The TNR system 110 can be incorporated in an Image Signal Processor (ISP). TNR reduces temporal noise, which often manifests as flickering or temporal graininess in video sequence. In some examples, a TNR algorithm analyzes consecutive frames in a video sequence, identifies moving and static regions, and applies spatial and/or temporal filters to effectively reduce noise and obtain a temporally and spatially clean image sequence.

The TNR system 110 implements temporal noise reduction in an image processing pipeline. The input 105 to the TNR system 110 can be an image, such as an image frame of a video. In the TNR system 110, the input 105 is received at a blending block 120, which performs a blending operation to reduce temporal noise by combining the current input with feedback data 135 from previous frames. In TNR algorithms, two key images are generated: a feedback image, which is saved to a memory 130, and a clean output image, which is output as output 140. The feedback image and the output image are generated at the blending block 120 using a blending operation, which is governed by a weights map, allowing for adaptive blending.

In various examples, the blending block 120 is configured to adaptively blend the current input image with a feedback image, which is stored and managed in memory 130. In some examples, the memory 130 is double data rate (DDR) memory. A feedback image based on the current frame, feedback[n] 125, is generated by the blending block 120 and written to the memory 130. For subsequent frames, the feedback image from the previous frame, feedback[n−1] 135, is retrieved from the memory 130 and supplied back to the blending block 120. In particular, the output image Iₒᵤₜₚᵤₜ[n] is recursively denoised by averaging the pixels from the current input image Iₙₚᵤₜ[n] with the feedback image I_{fb}[n−1]:

$${I}_{fb} [ n ] = {W}_{f} * {I}_{fb} [ n - 1 ] + ( 1 - {W}_{f} ) * {I}_{input} [ n ] \qquad ( 1 )$$

$${I}_{output} [ n ] = {W}_{o} * {I}_{fb} [ n - 1 ] + ( 1 - {W}_{o} ) * {I}_{input} [ n ] \qquad ( 2 )$$

where W_{f} is the weight of the feedback image, and Wₒ is the weight of the output image. When the TNR system 110 is used for denoising, the weights W_{f} and Wₒ are determined based on motion maps and user preference.

In some examples, the recursive process enables the system to maintain a temporally consistent and denoised image sequence.

In some examples, the memory 130 serves as a frame buffer, storing feedback images across frames to facilitate the blending process. The output of the blending block 120, after the blending operation, is provided as output 140, which can represent a denoised version of the input image.

While background replacement systems do not benefit from using a TNR system 110 since the background is being replaced and the foreground is usually dynamic, the TNR system 110 hardware can be used to construct and refine the background and store the background in the memory 130. In particular, systems and methods are provided herein to use the TNR system 110 in a background replacement system to dynamically construct and refine a background prior by recursively updating the feedback image based on the exposure of background regions in the input sequence. Thus, in some examples, by leveraging the memory 130, the TNR system 110 can efficiently access and update the background model over time for background replacement in video conferencing. This approach allows for the separation of static and dynamic regions, supporting improved segmentation accuracy and temporal coherence in downstream tasks such as foreground-background separation.

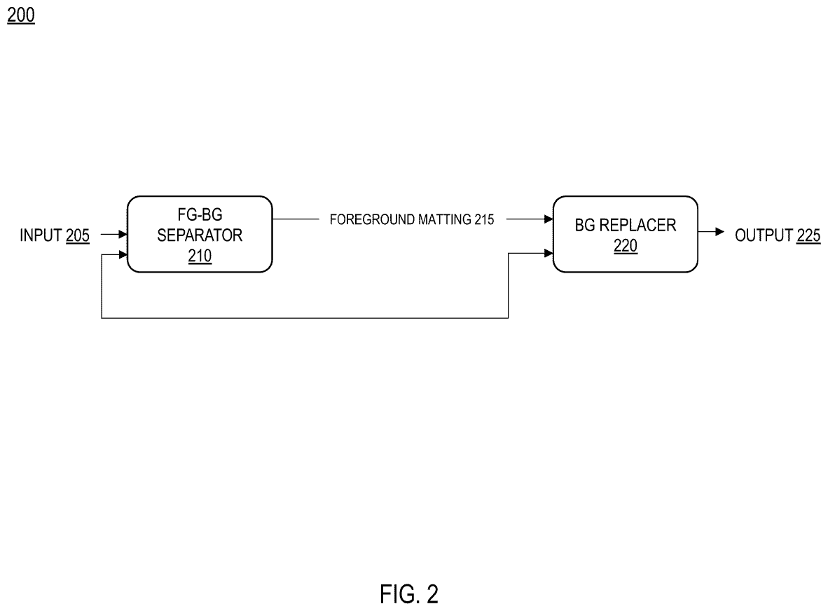

FIG. 2 is a block diagram of a foreground segmentation system 200 that can be used in a background replacement system. The foreground segmentation system 200 receives an input 205, which may be an image frame from a video. The input 205 is provided to a foreground-background separator 210. The foreground-background separator 210 analyzes the input image to generate a foreground matting map 215, which identifies the pixels corresponding to the foreground subject and distinguishes the foreground subject pixels from the background. The foreground matting map is used to accurately segment the subject, particularly in scenarios involving fine details or ambiguous regions. In some examples, the foreground matting map 215 is a per-pixel probability (alpha) map that indicates, for each pixel in a video frame, the likelihood that the pixel belongs to the foreground subject rather than the background.

The foreground matting map 215, along with the original input 205, is then supplied to the background replacer 220. The background replacer 220 utilizes the matting information to substitute the background region of the input image 205 with a new background or to apply background effects, as requested by the application. The result of the operation performed by the background replacer 220 is provided as output 225, which represents the final processed image for display or for further use in a video conferencing application.

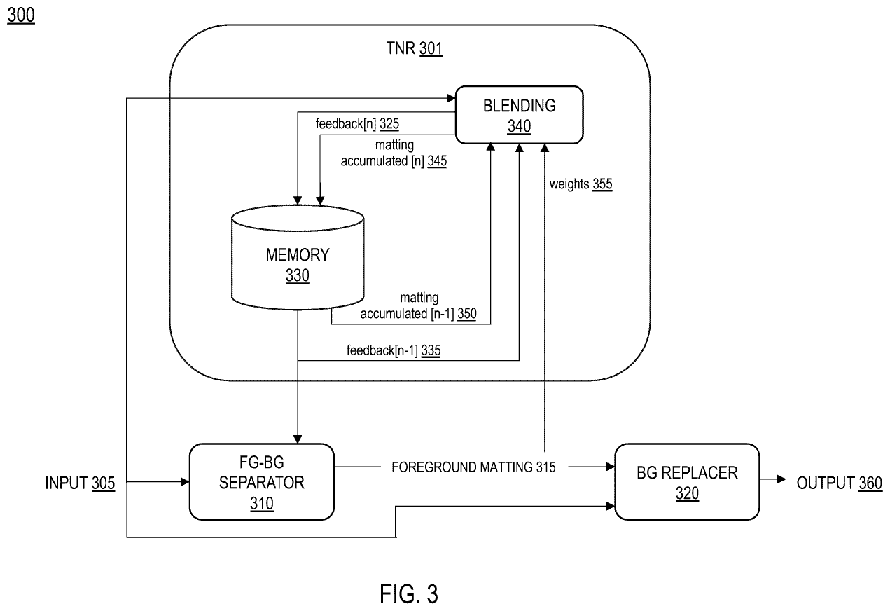

FIG. 3 is a block diagram of a background replacement system 300, in accordance with various embodiments. The background replacement system 300 includes an enhanced architecture for background replacement in video processing, integrating a temporal noise reduction system 301 with foreground-background separation and background replacement. The input 305 to the background replacement system 300 can be an image, such as an image frame of a video. According to various examples, the input 305 is processed by a foreground-background separator 310 and is also received at the blending block 340 of a TNR system 301. The foreground-background separator 310 generates a foreground matting 315 including weights 355. The foreground matting 315 identifies the regions of the image corresponding to the foreground subject and is used for accurate segmentation, including segmentation of fine details and ambiguous objects.

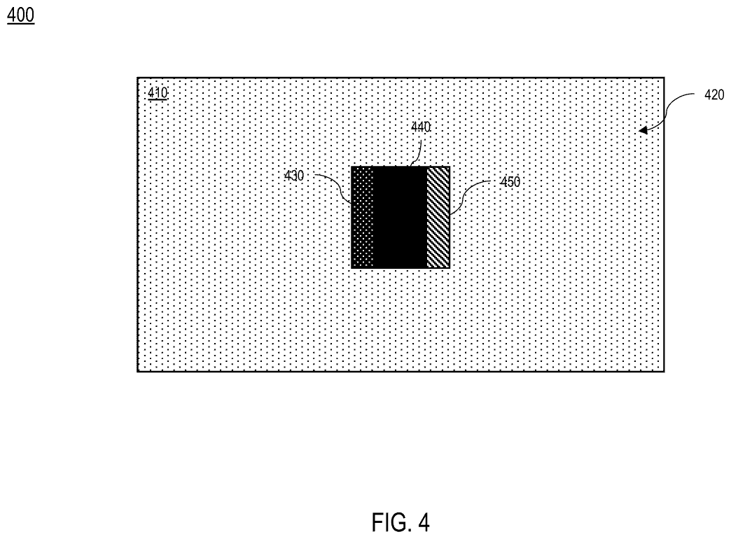

The weights 355 and the input 305 are also input to a TNR system 301 for additional processing. The TNR system 301 generates an updated version of the background for each image the TNR system 301 receives. The updated version of the background can be based on one or more previous versions of the background. Thus, in some examples, the TNR system 301 uses a current frame and a previous frame to update the background. In some examples, the two frames used at the TNR include four different types of areas, as described in greater detail with respect to FIG. 4.

FIG. 4 is a diagram 400 shows a frame 410 illustrating the four different regions of overlap of consecutive frames of a video, in accordance with various embodiments. The image frame 410 represents a video frame in which a foreground rectangle moves laterally, revealing and occluding portions of the scene background (region 420). The rectangle is partitioned into three vertical bands indicating regions 430, 440, and 450, each corresponding to a distinct background exposure state used by the temporal noise reduction pipeline to maintain and refine a background prior. Specifically, a first band denotes a first-time exposed background region 430 (pixels newly revealed in the current frame), a second band denotes a never-exposed background region 440 (pixels still occluded by the foreground in the current and previous frames), and a third band denotes a now-hidden background region 450 (pixels that were exposed in prior frames but are occluded in the current frame). The area outside the rectangle, the region 420, represents an exposed background region (pixels visible in both the current and previous frames).

Pixels in the first-time exposed region 430 are treated as immediate candidates to refresh the background prior. In particular, referring to FIG. 3, the blending block 340 copies the current frame values for these pixels into the background prior, and a matting accumulation register flags them as observed for the first time. This policy accelerates convergence of the prior when new portions of the background are revealed by foreground motion, reducing ambiguity for downstream segmentation.

For the exposed background region 420, the system either copies the current frame directly into the prior or averages it with the previously stored prior to smooth minor model or sensor fluctuations. This preserves temporal coherence where the background remains visible, and stabilizes fine details that are important for clean boundaries in subsequent foreground extraction.

Pixels in the now-hidden region 450 do not update from the current frame. Instead, the system retains the previously stored background values. This prevents the foreground subject from leaking into the background prior when occlusion occurs, ensuring that the prior remains a true estimate of what lies behind the subject and supporting accurate separation when those pixels reappear.

The never-exposed region 440 remains unchanged until exposure occurs in a later frame. By withholding updates in the never-exposed region 440, the system avoids fabricating background content in areas the camera has not yet observed, which in turn guides the foreground-background separator 310 to maintain foreground classification and prevents temporal artifacts. In some examples, the regions 420, 430, 440, and 450 form the per-frame “region map” that drives adaptive background construction and coherently informs segmentation and replacement operations elsewhere in the pipeline

Referring to equation (1) above, for each region 420, 430, 440, 450 of the input 305, the weights for the feedback image W_{f} can be different. In particular, the feedback image represents the best-known background so far. Thus, the weights value for each region 420, 430, 440, 450 can be determined as follows:

For the exposed region 420, the feedback image can copy the input image. Thus, the weights for the region 420 are:

$${W}_{f} = 0 \to {I}_{fb} [ n ] = {I}_{input} [ n ] \qquad ( 3 )$$

In some examples, for the exposed region 420, instead of copying the input image, the input image the previous feedback image can be averaged

$$( {W}_{f} = \frac{1}{2} )$$

to smooth any foreground matting estimation errors.

For the first-time exposed region 430, the feedback image can copy the input image. Thus, the weights for the region 430 are:

$${W}_{f} = 0 \to {I}_{fb} [ n ] = {I}_{input} [ n ] \qquad ( 3 )$$

For the never exposed region 440, the feedback image can copy the previous feedback (which includes the initial value for the background). Thus, the weights for the region 440 are:

$${W}_{f} = 1 \to {I}_{fb} [ n ] = {I}_{fb} [ n - 1 ] \qquad ( 4 )$$

For the now-hidden region 450, the feedback image can copy the previous feedback. Thus, the weights for the region 450 are:

$${W}_{f} = 1 \to {I}_{fb} [ n ] = {I}_{fb} [ n - 1 ] \qquad ( 4 )$$

Referring to FIG. 3, the blending block 340 combines the current input image with feedback images from previous frames to generate a recursively updated background prior. In particular, the blending block 340 receives the input 305, the prior background image feedback[n−1] 335 read from memory 330, the previous (matting accumulated [n−1]), and weights 355 that control the per-pixel mixing of the current frame and the stored background prior. In some examples, the accumulation map is a per-pixel temporal map that indicates the exposure history and confidence of the background overtime. In some examples, the accumulation map can be a confidence map including a per-pixel confidence value. In some examples, the accumulation map is a binary map indicating whether a pixel has previously been observed as background. In general, the matting accumulated signal indicates how long each pixel has been observed as background and remained sufficiently static to be confidently averaged into the running background prior.

The weights 355 can be generated by the separator 310, and are derived from its foreground matting 315 (i.e., the per-pixel foreground probabilities) together with the exposure history tracked by the matting accumulation signals. Using the weights 355, the blending block 340 constructs an updated background prior that excludes pixels classified as foreground and preserves previously observed background behind newly occluded regions. The updated background prior is output as feedback[n] 325 and the accumulation map is updated as matting accumulated[n] 345. The feedback[n] 325 for the current frame and the matting accumulated[n] 345 are stored in the memory 330.

The memory 330 serves as the persistent store for temporal signals across frames. The memory 330 holds the latest background prior feedback[n] 325 and the previous background prior feedback[n−1]335, along with the accumulation maps matting accumulated[n] 345 and matting accumulated[n−1] 350. Regions never exposed to the camera remain unchanged in memory 330, while first-time or repeatedly exposed regions are refreshed using the current input 305 according to weights 355. The memory 130 provides the foreground-background separator 310 with the current background prior image. In particular, the memory 130 provides the separator 310 with the best-known reconstructed background (e.g., feedback[n] 325 as available at inference time), and the separator can use the feedback[n] 325 as a reference. In some implementations, the separator 310 may also use a binarized or continuous form of matting accumulated[n] 345 to indicate which pixels of the background prior are reliable.

According to various examples, the foreground-background separator 310 operates on two inputs: the live image frame input 305 and the background prior image retrieved from memory 330 (i.e., feedback[n] 325). Using the background prior, the separator 310 resolves ambiguous regions (e.g., strands of hair, accessories, or objects a user is holding) and improves delineation where the background is currently occluded. The separator 310 outputs a probabilistic foreground matting 315. The foreground matting 315 is passed forward to the background replacer 320 to drive background substitution. Additionally, the foreground matting 315 is converted into the weights 355 that are provided to the blending block 340 inside TNR system 301. In some examples, the weights 355 cause the blending block 340 to suppress updates to the background prior for pixels determined to be foreground (near 1.0 in the matting), and to allow the background prior to be refreshed from the current frame for pixels determined to be background (near 0.0).

The background replacer 320 receives the input 305 and the foreground matting 315 and produces the final composite output 360. Using the foreground matting 315 as an alpha map, the background replacer 320 replaces or modifies the background region while preserving the foreground subject. Because the foreground-background separator 310 is guided by the background prior from the memory 330, the matting exhibits crisper boundaries and improved temporal coherence, which reduces visible artifacts during live conferencing and yields a higher-quality output 360.

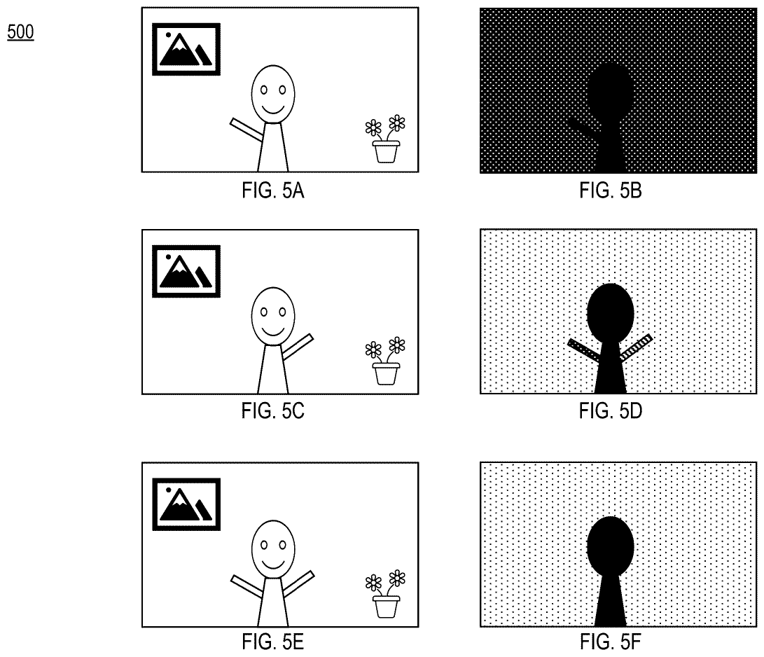

FIGS. 5A-5F illustrate pairs of current images with corresponding region maps, in accordance with various embodiments. In particular, FIGS. 5A, 5C, and 5E are renderings of example current images. FIG. 5B is a region map corresponding to the image frame of FIG. 5A. As shown in FIG. 5B, the foreground is the outline of the person in the image frame of FIG. 5A, and the background region behind the person is all “first time exposed” region. FIG. 5C illustrates a subsequent image frame following the image in FIG. 5A. In FIG. 5C, the person has put down their right arm and raised their left arm. FIG. 5D is a region map corresponding to the image frame of FIG. 5C. In FIG. 5D, the majority of the background is now an “exposed” region that has been previously exposed. The area of the background that had been behind the right arm is a “first time exposed region”. The area of the background that is now hidden behind the person's left arm is a “now hidden” region. FIG. 5E illustrates a subsequent image frame following the image in FIG. 5C. In FIG. 5E, the person has put down both arms. FIG. 5F is a region map corresponding to the image frame of FIG. 5E. In FIG. 5E, the background behind the person is an “exposed” region, as there are no new occlusions, or body parts hiding the background. In general, as the person moves slightly from left to right during a video conference, additional background area behind the person can be added to the background prior. The additional background knowledge can aid the background replacement system in distinguishing fine details for accurate foreground segmentation.

### Example Method for Background Replacement

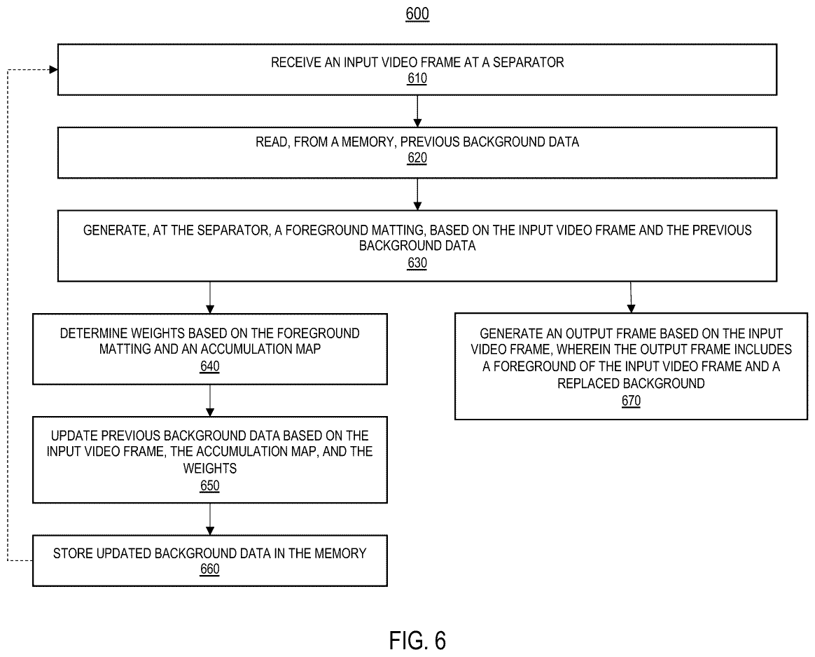

FIG. 6 is a flowchart showing a method 600 for background replacement, in accordance with various embodiments. Although the method 600 is described with reference to the flowchart illustrated in FIG. 6, many other methods for background replacement may alternatively be used. For example, the order of execution of the elements in FIG. 6 may be changed. As another example, some of the steps may be changed, eliminated, or combined. In various examples, the method 600 can be implemented by a background replacement system, such as the background replacement system 300 of FIG. 3.

At 610, an input video frame is received at a separator. In some examples, the input video frame can be a video frame from a video conferencing application. At 620, previous background data is read from a memory. In particular, the separator receives the previous background data from the memory. In some examples, the previous background data serves as a background prior that was constructed and persisted from previous video frames. The separator can use the background prior to inform current frame processing. In various examples, the memory can be a DDR frame store used by a TNR system. The memory can store previous background data including, for example, the most recent background prior and an accumulation map.

At 630, the separator generates a foreground matting from the input frame using the previously read background prior as a reference. In some examples, the foreground matting can be a per-pixel probability map indicating, for each pixel, whether the pixel belongs to the foreground subject. In some examples, using the background prior allows the separator to resolve occlusions and boundary ambiguities (e.g., hair strands, handheld items, accessories) more robustly than segmentation based only on the current frame. In some examples, the foreground matting is a mask used for downstream compositing at a background replacer. Additionally, the foreground matting provides information used to determine per-pixel background data updates. In some examples, the foreground matting includes per-pixel alpha values that modulate the compositing and weight calculation. In some examples, the separator uses the background prior to resolve occlusions, including edge pixels between foreground and background regions of the video frame.

At 640, weights are determined as a function of the foreground matting and an accumulation map. The accumulation map is a temporal exposure history for each pixel indicating how long (or whether) the background at the respective pixel has been observed to be static and reliable. In some examples, the accumulation map can include a continuous value for each pixel, wherein the value indicates a length of exposure and/or a confidence of background value accuracy. In some examples, the accumulation map can include a binary value for each pixel, wherein the value indicates whether the background for that pixel has been exposed (previously and/or currently). In some examples, the weights can be determined at the separator. In some examples, the weights can be determined within the TNR system, such as at a blending block. The blending block can use previous background data, such as a background prior and an accumulation map, as well as the foreground matting to determine the weights. In some examples, weights are determined based, at least in part, on a region map. To generate a region map, the input video frame is processed, and each pixel of the input frame is classified as one of four categories: never exposed background, first time exposed background, exposed background (previously exposed and currently exposed), and now hidden background (previous exposed background now hidden). A TNR blending block may determine how to update the background prior based, at least in part, on the region map.

In various examples, the weights used at 640 may be generated at the separator based on the foreground matting and the accumulation map. In some examples, the weights used at 640 may be generated at the TNR blending block, which receives the foreground matting and accumulation map inputs. In some examples, the accumulation map can be a per-pixel exposure count and/or confidence. In some examples, the accumulation map can be a binary map indicating whether the background has ever been observed for each pixel.

At 650, the method updates the previous background data using the input video frame, the accumulation map, and the weights. In some examples, a TNR blending block operation is used to mix the current input with the stored background prior based on the weights. The blending operation can be a per-pixel operation. In various examples, the blending block operation updates the background prior where pixels are confidently background and preserves background prior values where the background is hidden in the current input frame by the moving foreground. In some examples, pixels classified as foreground are not updated, preventing leakage of the foreground subject into the background prior. At 650, updating previous background data can include generating an updated accumulation map. In various examples, the update at 650 can include blending based on the region map, with optional edge aware smoothing of weights near boundaries to reduce artifacts.

At 660, the updated background data is stored in the memory, updating the background prior so that the next execution of 620-650 of the method 600 can read (and further refine) the updated background data. In some examples, the updated accumulation map is stored in the memory and used (and further updated) in the next execution of 620-650 of the method 600. In some examples, storing the temporal signals in high-speed memory supports real time operation and stable, low latency prior access for the separator and TNR pipeline in the following frames.

At 670, an output frame is generated by compositing the original input video frame with the foreground matting, thereby producing an image in which the foreground component of the input frame is preserved, and the background is replaced or modified (e.g., the background can be modified or replaced with a virtual image, blur, solid color, etc.). Because segmentation is guided by the background prior and temporal maps, the output frame exhibits improved boundary fidelity (notably at fine details, such as hair), reduced flicker, and greater temporal coherence across frames.

### Example DNN

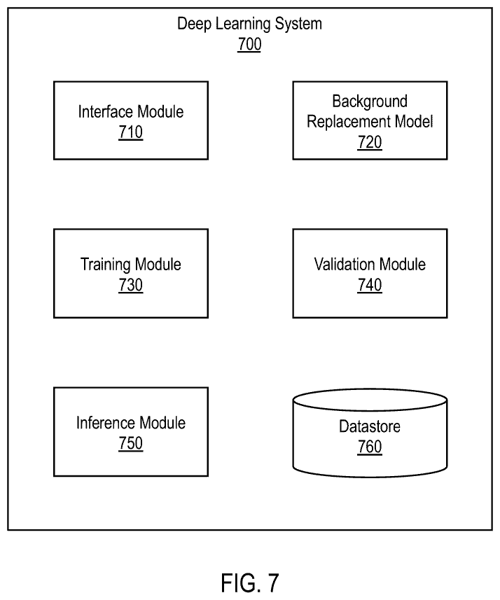

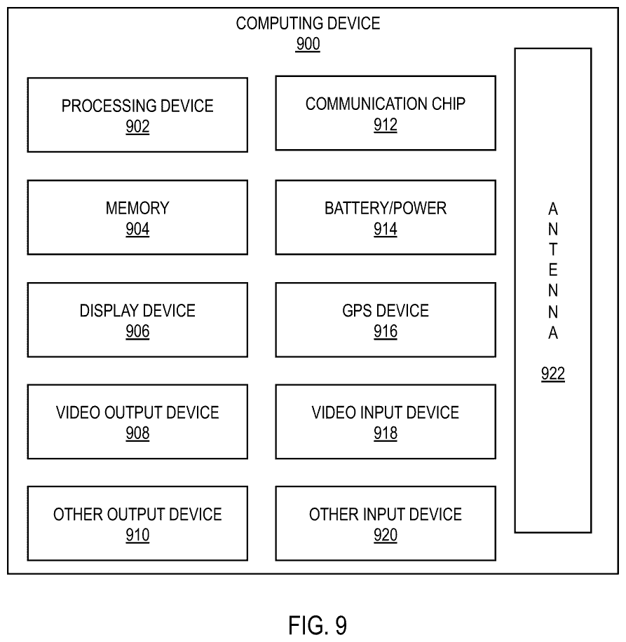

FIG. 7 is a block diagram of an example DNN system 700, in accordance with various embodiments. The DNN system 700 trains DNNs for various tasks, including background replacement for video. The DNN system 700 includes an interface module 710, a background replacement model 720, a training module 730, a validation module 740, an inference module 750, and a datastore 760. In other embodiments, alternative configurations, different or additional components may be included in the DNN system 700. Further, functionality attributed to a component of the DNN system 700 may be accomplished by a different component included in the DNN system 700 or a different system. The DNN system 700 or a component of the DNN system 700 (e.g., the training module 730 or inference module 750) may include the computing device 900 in FIG. 9.

The interface module 710 facilitates communications of the DNN system 700 with other systems. As an example, the interface module 710 supports the DNN system 700 to distribute trained DNNs to other systems, e.g., computing devices configured to apply DNNs to perform tasks. As another example, the interface module 710 establishes communications between the DNN system 700 with an external database to receive data that can be used to train DNNs or input into DNNs to perform tasks. In some embodiments, data received by the interface module 710 may have a data structure, such as a matrix. In some embodiments, data received by the interface module 710 may be an image, a series of images, and/or a video stream.

The background replacement model 720 segments foreground and background in input video frames. In some examples, the background replacement model 720 performs background replacement in input video images from video conferencing applications. In general, the background replacement model includes a temporal noise reduction module used to provide and update a background prior and an accumulation map, and a foreground segmentation module. The background replacement model 720 receives video image data, and generates an output video frame in which the foreground remains the same as in the input video frame and the background is replaced (e.g., virtual image) or modified (e.g., blur, solid color).

The training module 730 trains DNNs by using training datasets. In some embodiments, a training dataset for training a DNN may include one or more images and/or videos, each of which may be a training sample. In some examples, the training module 730 trains the background replacement model 720. The training module 730 may receive real-world image data for processing with the background replacement model 720 as described herein. In some embodiments, the training module 730 may input different data into different layers of the DNN. For every subsequent DNN layer, the input data may be less than the previous DNN layer. In some examples, the background replacement model 720 can be trained with ground truth foreground/background maps of images. In some examples, the difference between background replacement model 720 foreground classification map output and the corresponding groundtruth foreground classification map can be measured as the number of pixels in the corresponding maps that have different classifications from each other.

In some embodiments, a part of the training dataset may be used to initially train the DNN, and the rest of the training dataset may be held back as a validation subset used by the validation module 740 to validate performance of a trained DNN. The portion of the training dataset not including the tuning subset and the validation subset may be used to train the DNN.

The training module 730 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 1, 10, 50, 100, or even larger.

The training module 730 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include three channels). A pooling layer is used to reduce the spatial volume of input image after convolution. It is used between two convolution layers. A fully connected layer involves weights, biases, and neurons. It connects neurons in one layer to neurons in another layer. It is used to classify images between different categories by training.

In the process of defining the architecture of the DNN, the training module 730 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 730 defines the architecture of the DNN, the training module 730 inputs a training dataset into the DNN. The training dataset includes a plurality of training samples. An example of a training dataset includes a series of images of a video stream. Unlabeled, real-world video is input to the background replacement model, and processed using the background replacement model parameters of the DNN to produce model-generated outputs. In some embodiments, the training module 730 uses a cost function to minimize the differences.

The training module 730 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 730 finishes the predetermined number of epochs, the training module 730 may stop updating the parameters in the DNN. The DNN having the updated parameters is referred to as a trained DNN.

The validation module 740 verifies accuracy of trained DNNs. In some embodiments, the validation module 740 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 740 may determine an accuracy score measuring the precision, recall, or a combination of precision and recall of the DNN. The validation module 740 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 740 may compare the accuracy score with a threshold score. In an example where the validation module 740 determines that the accuracy score of the augmented model is lower than the threshold score, the validation module 740 instructs the training module 730 to re-train the DNN. In one embodiment, the training module 730 may iteratively re-train the DNN until the occurrence of a stopping condition, such as the accuracy measurement indication that the DNN may be sufficiently accurate, or a number of training rounds having taken place.

The inference module 750 applies the trained or validated DNN to perform tasks. The inference module 750 may run inference processes of a trained or validated DNN. In some examples, inference makes use of the forward pass to produce model-generated output for unlabeled real-world data. For instance, the inference module 750 may input real-world data into the DNN and receive an output of the DNN. The output of the DNN may provide a solution to the task for which the DNN is trained for.

The inference module 750 may aggregate the outputs of the DNN to generate a final result of the inference process. In some embodiments, the inference module 750 may distribute the DNN to other systems, e.g., computing devices in communication with the DNN system 700, for the other systems to apply the DNN to perform the tasks. The distribution of the DNN may be done through the interface module 710. In some embodiments, the DNN system 700 may be implemented in a server, such as a cloud server, an edge service, and so on. The computing devices may be connected to the DNN system 700 through a network. Examples of the computing devices include edge devices.

The datastore 760 stores data received, generated, used, or otherwise associated with the DNN system 700. For example, the datastore 760 stores video processed by the background replacement n model 720 or used by the training module 730, validation module 740, and the inference module 750. The datastore 760 may also store other data generated by the training module 730 and validation module 740, such as the hyperparameters for training DNNs, internal parameters of trained DNNs (e.g., values of tunable parameters of activation functions, such as Fractional Adaptive Linear Units (FALUs)), etc. In the embodiment of FIG. 7, the datastore 760 is a component of the DNN system 700. In other embodiments, the datastore 760 may be external to the DNN system 700 and communicate with the DNN system 700 through a network.

For background replacement model training, the input can include an input image frame and a labeled groundtruth background replacement model-processed image. In various examples, the input image frame is received at a temporal noise reducer such as the background replacement model of image processing system 300, or the background replacement model 720. In other examples, the input image frame can be received at the training module 730 or the inference module 750 of FIG. 7. The imager can be a camera, such as a video camera. The input image frame can be a still image from the video camera feed. The input image frame can include a matrix of pixels, each pixel having a color, lightness, and/or other parameter. The input image frame can be downscaled and processed by the motion analysis block, and the input image frame can be simultaneously processed (in parallel) by an image processing pipe. The output from the motion analysis block and the output from the image processing pipe can be input to a blending module, which can also retrieve previous output image from a memory. The blending module can remove noise from the processed input image and generate a clean output image. Temporal noise reduction parameters, such as blend factors, are adjusted to minimize a loss function between the clean output image and the labeled groundtruth background replacement model-processed image. Various steps can be repeated to further adjust the background replacement model parameters. In some examples, the training can be repeated with a new input image frame and groundtruth background replacement model-processed image. In some examples, the motion analysis block can be trained using downscaled input images and comparing motion analysis block motion map outputs to groundtruth motion maps. Similarly, in some examples, the blending module can be trained using processed background replacement model input images and downscaled motion maps, and comparing blending module clean processed output images to groundtruth clean processed output images.

### Example Neural Network for Background Replacement

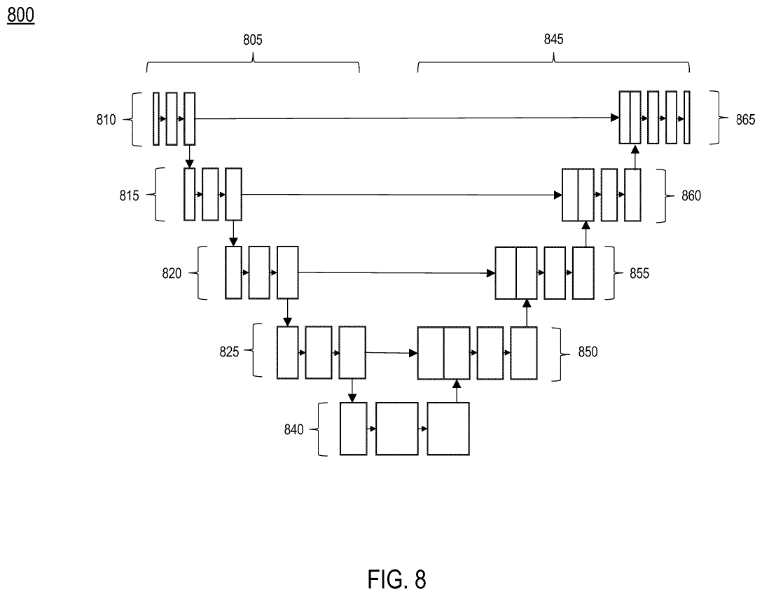

FIG. 8 is a block diagram of a background replacement neural network 800, in accordance with various embodiments. The background replacement neural network 800 receives an input image, for example a video frame from a video conferencing application. The background replacement neural network 800 model analyzes the image data, and distinguishes foreground areas from background areas. In some examples, a foreground-background separator, such as the separator 310 of FIG. 3, is implemented as the background replacement neural network 800, and the background replacement neural network 800 receives the input image and the previous background data as input and outputs a foreground matting. In some examples, the background replacement neural network 800 outputs a confidence map that is used to determine the weights for the blending block.

The background replacement neural network 800, as shown in FIG. 8, is a Convolutional Neural Network (CNN), a type of deep learning model. Additionally, the background replacement neural network 800 as shown in FIG. 8 has a U-Net shaped architecture, including an encoder 805 and a decoder 845. The input to the background replacement neural network 800 is an image, such as an image frame from a video conferencing application, and previous background data, such as a previous background prior. The resolution of the input image is M×N×3.

In the encoder 805 stage, the background replacement neural network 800 includes several layers, grouped in the U-Net architecture into first layers 810, second layers 815, third layers 820, and fourth layers 825, each operating on a different scale (i.e., different spatial dimensions) and designed to extract distinct features from the input image. In various examples, the first layers 810, second layers 815, third layers 820, and fourth layers 825 each include multiple layers, including two convolutional layers and one max pooling layer. In particular, the first two layers in each group operate on a larger spatial dimension, applying a series of filters to the image to detect low-level features like edges and textures. In some examples, the first two layers in each group are 3×3 convolution layers. These layers are followed by max pooling layers, which reduce the data's dimensionality while preserving the most important information and increasing the number of channels. In some examples, the max pooling layers are 2×2 max pooling layers. In some examples, the increase in the number of channels is designed to incorporate semantic knowledge into the background replacement process. In some examples, the output from the max pooling layer is received at a next convolutional layer. The output from the max pooling layer can also be connected to a corresponding decoding layer via a skip connect.

The convolution layers and max pooling are repeated four times, in first layers 810, second layers 815, third layers 820, and fourth layers 825, to reach the bottleneck information at the fifth layer 840. In some examples, the fifth layer 840 has the size of M/16×N/16×1024. The fifth layer includes two 8×3 convolutional layers and a 2×2 up-convolution layer, in which a 2×2 up-convolution operator is applied to upscale the feature maps to a higher scale.

In the decoder 845 stage, the background replacement neural network 800 includes several layers, grouped in the U-Net architecture into fourth layers 850, third layers 855, second layers 860, and first layers 865, each operating on a different scale. At each stage, a 2×2 up-convolution operator is applied to upscale the feature maps to a higher scale. A concatenation operator then combines the matching scale from the corresponding encoder layer, via the skip connect. This is followed by several convolution layers to process the upscaled and concatenated features together. These operations are repeated in the decoder stage until the spatial resolution of the input image is restored. The background replacement neural network's final layer is a 1×1 convolution layer, which serves as a fully connected layer per pixel, combining the features extracted by the previous layers to make the final foreground and background classification predictions.

In particular, the background replacement neural network 800 classifies each pixel in the input image as belonging to foreground or background. The classification provides a guide for how each pixel is processed in subsequent processing stages, such as at the blending block 340 of FIG. 3. In various embodiments, the background replacement neural network 800 outputs a foreground-background classification map based on the predicted classifications of each pixel.

In various implementations, as described, for example, with respect to FIG. 3, the foreground matting map output from the separator 310 is the output from the background replacement neural network 800.

### Example Training of a Background Replacement Module

In various embodiments, the background replacement neural network 800 is trained using a combined loss function that includes both soft Dice Loss and Binary Cross-Entropy (BCE) loss, a methodology frequently employed in image segmentation tasks. The BCE loss quantifies the pixel-wise agreement between the predicted foreground matting maps and the ground truth, whereas the soft Dice loss is used for achieving precise boundary localization. In some embodiments, the background replacement neural network 800 can incorporate a pre-trained semantic segmentation model with minimal changes to the architecture illustrated in FIG. 8.

The training dataset for the background replacement neural network (e.g., background replacement neural network 800) includes a large collection of high-quality, low-noise images. These images are diverse and representative of the variety of background scenes, objects, and lighting conditions and the variety of foreground objects and details that the model is likely to encounter in real-world applications. In various implementations, the images can be supplemented with additional images, such as selections from publicly available image datasets. For each image in the training dataset, the ground truth is defined as the optimally calculated foreground vs. background classification for each pixel in the image. The method for automatically generating the ground truth is self-supervised and utilizes a high-quality background replacement algorithm. The high-quality background replacement algorithm can accurately capture foreground details across a broad spectrum of images. Additionally, the high-quality background replacement algorithm operates offline with minimal computational constraints, serving as a preprocessing step prior to the training phase.

### Example Computing Device

FIG. 9 is a block diagram of an example computing device 900, in accordance with various embodiments. In some embodiments, the computing device 900 may be used for at least part of the deep learning system 700 in FIG. 7. A number of components are illustrated in FIG. 9 as included in the computing device 900, but any one or more of these components may be omitted or duplicated, as suitable for the application. In some embodiments, some or all of the components included in the computing device 900 may be attached to one or more motherboards. In some embodiments, some or all of these components are fabricated onto a single system on a chip (SoC) die. Additionally, in various embodiments, the computing device 900 may not include one or more of the components illustrated in FIG. 9, but the computing device 900 may include interface circuitry for coupling to the one or more components. For example, the computing device 900 may not include a display device 906, but may include display device interface circuitry (e.g., a connector and driver circuitry) to which a display device 906 may be coupled. In another set of examples, the computing device 900 may not include a video input device 918 or a video output device 908, but may include video input or output device interface circuitry (e.g., connectors and supporting circuitry) to which a video input device 918 or video output device 908 may be coupled.

The computing device 900 may include a processing device 902 (e.g., one or more processing devices). The processing device 902 processes electronic data from registers and/or memory to transform that electronic data into other electronic data that may be stored in registers and/or memory. The computing device 900 may include a memory 904, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 904 may include memory that shares a die with the processing device 902. In some embodiments, the memory 904 includes one or more non-transitory computer-readable media storing instructions executable for enhancing background replacement, e.g., the method 600 described above in conjunction with FIG. 6 or some operations performed by the background replacement system 300 in FIG. 3 or the DNN system 700 in FIG. 7. The instructions stored in the one or more non-transitory computer-readable media may be executed by the processing device 902.

In some embodiments, the computing device 900 may include a communication chip 912 (e.g., one or more communication chips). For example, the communication chip 912 may be configured for managing wireless communications for the transfer of data to and from the computing device 900. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 912 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 912 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 912 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 912 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 912 may operate in accordance with other wireless protocols in other embodiments. The computing device 900 may include an antenna 922 to facilitate wireless communications and/or to receive other wireless communications (such as AM or FM radio transmissions).

In some embodiments, the communication chip 912 may manage wired communications, such as electrical, optical, or any other suitable communication protocols (e.g., the Ethernet). As noted above, the communication chip 912 may include multiple communication chips. For instance, a first communication chip 912 may be dedicated to shorter-range wireless communications such as Wi-Fi or Bluetooth, and a second communication chip 912 may be dedicated to longer-range wireless communications such as global positioning system (GPS), EDGE, GPRS, CDMA, WiMAX, LTE, EV-DO, or others. In some embodiments, a first communication chip 912 may be dedicated to wireless communications, and a second communication chip 912 may be dedicated to wired communications.

The computing device 900 may include battery/power circuitry 914. The battery/power circuitry 914 may include one or more energy storage devices (e.g., batteries or capacitors) and/or circuitry for coupling components of the computing device 900 to an energy source separate from the computing device 900 (e.g., AC line power).

The computing device 900 may include a display device 906 (or corresponding interface circuitry, as discussed above). The display device 906 may include any visual indicators, such as a heads-up display, a computer monitor, a projector, a touchscreen display, a liquid crystal display (LCD), a light-emitting diode display, or a flat panel display, for example.

The computing device 900 may include a video output device 908 (or corresponding interface circuitry, as discussed above). The video output device 908 may include any device that generates an audible indicator, such as speakers, headsets, or earbuds, for example.

The computing device 900 may include a video input device 918 (or corresponding interface circuitry, as discussed above). The video input device 918 may include any device that generates a signal representative of a sound, such as microphones, microphone arrays, or digital instruments (e.g., instruments having a musical instrument digital interface (MIDI) output).

The computing device 900 may include a GPS device 916 (or corresponding interface circuitry, as discussed above). The GPS device 916 may be in communication with a satellite-based system and may receive a location of the computing device 900, as known in the art.

The computing device 900 may include another output device 910 (or corresponding interface circuitry, as discussed above). Examples of the other output device 910 may include a video codec, a video codec, a printer, a wired or wireless transmitter for providing information to other devices, or an additional storage device.

The computing device 900 may include another input device 920 (or corresponding interface circuitry, as discussed above). Examples of the other input device 920 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 900 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 900 may be any other electronic device that processes data.

### Selected Examples

The following paragraphs provide various examples of the embodiments disclosed herein.

Example 1 provides an apparatus, including a computer processor for executing computer program instructions; and a non-transitory computer-readable memory storing computer program instructions executable by the computer processor to perform operations including receiving an input video frame at a separator; reading, at the separator, previous background data from a memory; determining, at the separator, a foreground matting based on the input video frame and the previous background data, where the foreground matting indicates a foreground component of the input video frame; determining weights based on the foreground matting and an accumulation map; updating the previous background data based on the input video frame, the accumulation map, and the weights; and generating, at a background replacer, an output frame based on the input video frame and the foreground matting, where the output frame includes the foreground component of the input video frame and a replaced background.

Example 2 provides the apparatus of example 1, the operations further including updating the accumulation map based on the input video frame and the weights.

Example 3 provides the apparatus of example 1 or 2, where the weights are generated at the separator as a function of the foreground matting and the accumulation map.

Example 4 provides the apparatus of any one of examples 1-3, where the weights are generated within a temporal noise reduction (TNR) block that receives the foreground matting and the accumulation map as inputs.

Example 5 provides the apparatus of any one of examples 1-4, where the previous background data includes a background prior image that excludes pixels classified as foreground in one or more earlier frames.

Example 6 provides the apparatus of any one of examples 1-5, where updating the previous background data includes blending the input video frame with the previous background data based on the weights to produce an updated background prior.

Example 7 provides the apparatus of example 6, where updating the previous background data includes and updating the accumulation map.

Example 8 provides the apparatus of any one of examples 1-7, where the accumulation map is a per-pixel exposure count or confidence value indicating how long a pixel has been observed as background.

Example 9 provides the apparatus of any one of examples 1-8, where the accumulation map is a binary map indicating whether a pixel has previously been observed as background.

Example 10 provides the apparatus of any one of examples 1-9, where the determining the weights includes determining a pixel region for each pixel of the input video frame, where the pixel region can be one of: (i) a never-exposed region in which there is no previous background data and no current background data; (ii) a first-time exposed region in which the previous background data is updated based on the input video frame; (iii) a previously exposed region in which the previous background data is updated based on the input video frame; and (iv) a now-hidden region in which the previous background data is preserved.

Example 11 provides the apparatus of any one of examples 1-10, where updating the previous background data further includes withholding updates for pixels classified as foreground based on the foreground matting, thereby preventing foreground leakage into the previous background data.

Example 12 provides the apparatus of any one of examples 1-11, where the foreground matting is a per-pixel alpha value in [0,1], and the weights are computed as a monotonic function of (1−alpha) modulated by a confidence derived from the accumulation map.

Example 13 provides the apparatus of any one of examples 1-12, where the separator is configured to receive the previous background data from the memory and use the previous background data as a reference to resolve occlusions and disambiguate hair, handheld objects, or accessories.

Example 14 provides the apparatus of any one of examples 1-13, where the memory includes double data rate (DDR) memory configured to persist the previous background data and the accumulation map between frames.

Example 15 provides one or more non-transitory computer-readable media storing instructions executable to perform operations, the operations including receiving an input video frame at a separator; reading, at the separator, previous background data from a memory; determining, at the separator, a foreground matting based on the input video frame and the previous background data, where the foreground matting indicates a foreground component of the input video frame; determining weights based on the foreground matting and an accumulation map; updating the previous background data based on the input video frame, the accumulation map, and the weights; and generating, at a background replacer, an output frame based on the input video frame and the foreground matting, where the output frame includes the foreground component of the input video frame and a replaced background.

Example 16 provides the one or more non-transitory computer-readable media of example 15, where the operations further include updating the accumulation map based on the input video frame and the weights.

Example 17 provides the one or more non-transitory computer-readable media of example 15 or 16, where the weights are generated at the separator as a function of the foreground matting and the accumulation map.

Example 18 provides the one or more non-transitory computer-readable media of any one of examples 15-17, where the weights are generated within a temporal noise reduction (TNR) block that receives the foreground matting and the accumulation map as inputs.

Example 19 provides the one or more non-transitory computer-readable media of any one of examples 15-18, where the previous background data includes a background prior image that excludes pixels classified as foreground in one or more earlier frames.

Example 20 provides the one or more non-transitory computer-readable media of any one of examples 15-19, where updating the previous background data includes blending the input video frame with the previous background data based on the weights to produce an updated background prior.

Example 21 provides the one or more non-transitory computer-readable media of example 20, where updating the previous background data further includes updating the accumulation map.

Example 22 provides the one or more non-transitory computer-readable media of any one of examples 15-21, where the accumulation map is a per-pixel exposure count or confidence value indicating how long a pixel has been observed as background.

Example 23 provides the one or more non-transitory computer-readable media of any one of examples 15-22, where the accumulation map is a binary map indicating whether a pixel has previously been observed as background.

Example 24 provides the one or more non-transitory computer-readable media of any one of examples 15-23, where determining the weights includes determining a pixel region for each pixel of the input video frame, where the pixel region is one of: (i) a never-exposed region in which there is no previous background data and no current background data; (ii) a first-time exposed region in which the previous background data is updated based on the input video frame; (iii) a previously exposed region in which the previous background data is updated based on the input video frame; and (iv) a now-hidden region in which the previous background data is preserved.

Example 25 provides the one or more non-transitory computer-readable media of any one of examples 15-24, where updating the previous background data further includes withholding updates for pixels classified as foreground based on the foreground matting, thereby preventing foreground leakage into the previous background data.

Example 26 provides the one or more non-transitory computer-readable media of any one of examples 15-25, where the foreground matting is a per-pixel alpha value in [0,1], and the weights are computed as a monotonic function of (1−alpha) modulated by a confidence derived from the accumulation map.

Example 27 provides the one or more non-transitory computer-readable media of any one of examples 15-26, where the separator is configured to receive the previous background data from the memory and use the previous background data as a reference to resolve occlusions and disambiguate hair, handheld objects, or accessories.

Example 28 provides the one or more non-transitory computer-readable media of any one of examples 15-27, where the memory includes double data rate (DDR) memory configured to persist the previous background data and the accumulation map between frames.

Example 29 provides a computer-implemented method including receiving an input video frame at a separator; reading, at the separator, previous background data from a memory; determining, at the separator, a foreground matting based on the input video frame and the previous background data, where the foreground matting indicates a foreground component of the input video frame; determining weights based on the foreground matting and an accumulation map; updating the previous background data based on the input video frame, the accumulation map, and the weights; and generating, at a background replacer, an output frame based on the input video frame and the foreground matting, where the output frame includes the foreground component of the input video frame and a replaced background.

Example 30 provides the method of example 29, further including updating the accumulation map based on the input video frame and the weights.

Example 31 provides the method of example 29 or 30, where the weights are generated at the separator as a function of the foreground matting and the accumulation map.

Example 32 provides the method of any one of examples 29-31, where the weights are generated within a temporal noise reduction (TNR) block that receives the foreground matting and the accumulation map as inputs.

Example 33 provides the method of any one of examples 29-32, where the previous background data includes a background prior image that excludes pixels classified as foreground in one or more earlier frames.

Example 34 provides the method of any one of examples 29-33, where updating the previous background data includes blending the input video frame with the previous background data based on the weights to produce an updated background prior.

Example 35 provides the method of any one of examples 29-34, further including updating the accumulation map while updating the previous background data.

Example 36 provides the method of any one of examples 29-35, where the accumulation map is a per-pixel exposure count or confidence value indicating how long a pixel has been observed as background.

Example 37 provides the method of any one of examples 29-36, where the accumulation map is a binary map indicating whether a pixel has previously been observed as background.

Example 38 provides the method of any one of examples 29-37, where determining the weights includes determining, for each pixel of the input video frame, a pixel region selected from: (i) a never-exposed region in which there is no previous background data and no current background data; (ii) a first-time exposed region in which the previous background data is updated based on the input video frame; (iii) a previously exposed region in which the previous background data is updated based on the input video frame; and (iv) a now-hidden region in which the previous background data is preserved.

Example 39 provides the method of any one of examples 29-38, where updating the previous background data further includes withholding updates for pixels classified as foreground based on the foreground matting, thereby preventing foreground leakage into the previous background data.

Example 40 provides the method of any one of examples 29-39, where the foreground matting includes per-pixel alpha values in [0,1], and the weights are computed as a monotonic function of (1−alpha) modulated by a confidence derived from the accumulation map.

Example 41 provides the method of any one of examples 29-40, further including using the previous background data as a reference at the separator to resolve occlusions and to disambiguate hair, handheld objects, or accessories.

Example 42 provides the method of any one of examples 29-41, further including persisting the previous background data and the accumulation map between frames in double data rate (DDR) memory.

Example 43 provides the apparatus, the one or more non-transitory computer-readable media, and/or the method of any of examples 1-42, wherein updating the previous background data includes updating the previous background data in a temporal noise reduction system.

Example 44 provides the apparatus, the one or more non-transitory computer-readable media, and/or the method of any of examples 1-42, wherein the memory is a temporal noise reduction system memory, wherein updating the previous background data includes updating the previous background data at a blending block in a temporal noise reduction system, and wherein the updated background data is stored in the memory.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. An apparatus, comprising:
a computer processor for executing computer program instructions; and
a non-transitory computer-readable memory storing computer program instructions executable by the computer processor to perform operations comprising:
receiving an input video frame at a separator;
reading, at the separator, previous background data from a memory;
determining, at the separator, a foreground matting based on the input video frame and the previous background data, wherein the foreground matting indicates a foreground component of the input video frame;
determining weights based on the foreground matting and an accumulation map;
updating the previous background data based on the input video frame, the accumulation map, and the weights; and
generating, at a background replacer, an output frame based on the input video frame and the foreground matting, wherein the output frame includes the foreground component of the input video frame and a replaced background.

2. The apparatus of claim 1, wherein updating the previous background data includes updating the previous background data in a temporal noise reduction system.

3. The apparatus of claim 1, the operations further comprising updating the accumulation map based on the input video frame and the weights.

4. The apparatus of claim 1, wherein the weights are generated at the separator as a function of the foreground matting and the accumulation map.

5. The apparatus of claim 1, wherein the previous background data comprises a background prior image that includes pixels classified as background in one or more earlier frames.

6. The apparatus of claim 1, wherein updating the previous background data includes blending the input video frame with the previous background data based on the weights to produce an updated background prior.

7. The apparatus of claim 6, wherein updating the previous background data includes updating the accumulation map.

8. The apparatus of claim 1, wherein the accumulation map is a per-pixel exposure count or confidence value indicating how long a pixel has been observed as background.

9. The apparatus of claim 1, wherein determining the weights includes determining a pixel region for each pixel of the input video frame, wherein the pixel region can be one of:
(i) a never-exposed region in which there is no previous background data and no current background data;
(ii) a first-time-exposed region in which the previous background data is updated based on the input video frame;
(iii) a previously-exposed region in which the previous background data is updated based on the input video frame; and
(iv) a now-hidden region in which the previous background data is preserved.

10. The apparatus of claim 1, wherein updating the previous background data further comprises withholding updates for pixels classified as foreground based on the foreground matting, thereby preventing foreground leakage into the previous background data.

11. One or more non-transitory computer-readable media storing instructions executable to perform operations, the operations comprising:
receiving an input video frame at a separator;
reading, at the separator, previous background data from a memory;
determining, at the separator, a foreground matting based on the input video frame and the previous background data, wherein the foreground matting indicates a foreground component of the input video frame;
determining weights based on the foreground matting and an accumulation map;
updating the previous background data based on the input video frame, the accumulation map, and the weights; and
generating, at a background replacer, an output frame based on the input video frame and the foreground matting, wherein the output frame includes the foreground component of the input video frame and a replaced background.

12. The one or more non-transitory computer-readable media of claim 11, wherein the operations further comprise updating the accumulation map based on the input video frame and the weights.

13. The one or more non-transitory computer-readable media of claim 11, wherein the weights are generated at the separator as a function of the foreground matting and the accumulation map.

14. The one or more non-transitory computer-readable media of claim 11, wherein the previous background data comprises a background prior image that includes pixels classified as background in one or more earlier frames.

15. The one or more non-transitory computer-readable media of claim 11, wherein updating the previous background data includes blending the input video frame with the previous background data based on the weights to generate an updated background prior.

16. The one or more non-transitory computer-readable media of claim 15, wherein updating the previous background data further comprises updating the accumulation map.

17. The one or more non-transitory computer-readable media of claim 11, wherein the accumulation map is a per-pixel exposure count or confidence value indicating how long a pixel has been observed as background.

18. The one or more non-transitory computer-readable media of claim 11, wherein determining the weights includes determining a pixel region for each pixel of the input video frame, wherein the pixel region is one of:
(i) a never-exposed region in which there is no previous background data and no current background data;
(ii) a first-time-exposed region in which the previous background data is updated based on the input video frame;
(iii) a previously-exposed region in which the previous background data is updated based on the input video frame; and
(iv) a now-hidden region in which the previous background data is preserved.

19. The one or more non-transitory computer-readable media of claim 11, wherein updating the previous background data further comprises withholding updates for pixels classified as foreground based on the foreground matting, thereby preventing foreground leakage into the previous background data.

20. A computer-implemented method comprising:
receiving an input video frame at a separator;
reading, at the separator, previous background data from a memory;
determining, at the separator, a foreground matting based on the input video frame and the previous background data, wherein the foreground matting indicates a foreground component of the input video frame;
determining weights based on the foreground matting and an accumulation map;
updating the previous background data based on the input video frame, the accumulation map, and the weights; and
generating, at a background replacer, an output frame based on the input video frame and the foreground matting, wherein the output frame includes the foreground component of the input video frame and a replaced background.
